(19) United States
(12) Patent Application Publication
(10) Pub. No.: US 2020/0372417 A1
(43) Pub. Date: Nov. 26, 2020

(54) On-Demand Travel Through a Transportation Network

(71) Applicants: Nissan North America, Inc., Franklin, TN (US); Renault S.A.S., Boulogne-Billancourt (FR)

(72) Inventors: Simon Tien, Santa Clara, CA (US); Najamuddin Baig, San Jose, CA (US); Viju James, Fremont, CA (US); Astha Vagadia, San Jose, CA (US); Armelle Guerin, Woodside, CA (US); Erik Vinkhuyzen, Morgan Hill, CA (US); Aude Laurent, Redwood City, CA (US)

(21) Appl. No.: 16/420,640

(22) Filed: May 23, 2019

(51) Int. Cl. G06Q 10/02; G06Q 50/30; G01C 21/34

(52) U.S. Cl. CPC G06Q 10/02; G01C 21/3476; G06Q 50/30

(57) ABSTRACT

On-demand travel through a transportation network is achieved by receiving, via a communication device, a request for a trip through the network using a vehicle. The request includes criteria for the trip and a goal for the trip, the criteria identifying a target duration of the trip, a starting location of the trip, and an ending location of the trip, and the goal is other than reaching the ending location from the starting location using a shortest time or a shortest distance. Based on the request; a route for the trip between the starting and ending locations is determined that has a predicted duration no greater than the target duration. The route includes a waypoint between the starting and ending locations determined based on the goal of the trip, and the route is transmitted, via the communication device, to a source of the request for traveling the route.

### TECHNICAL FIELD

This application relates to on-demand travel of a vehicle, such as an autonomous vehicle, through a transportation network.

### BACKGROUND

Increasing autonomous vehicle usage creates the potential for more efficient movement of passengers and cargo through a transportation network. Moreover, the use of autonomous vehicles can result in improved vehicle safety and more effective communication between vehicles.

### SUMMARY

Disclosed herein are aspects, features, elements, embodiments, and implementations of remotely supporting operation of a vehicle through a transportation network. The implementations support on-demand travel meeting criteria and a goal requested by a passenger of the vehicle.

An aspect of the disclosed implementations includes an apparatus for supporting travel through a transportation network. The apparatus includes a communication device and a processor. The processor is in connection with the communication device and may be configured to perform a method including receiving, via the communication device, a request for a trip through the transportation network using a vehicle, wherein the request includes criteria for the trip and a goal for the trip, the criteria identifying a target duration of the trip, a starting location of the trip, and an ending location of the trip, and the goal is other than reaching the ending location from the starting location using a shortest time or a shortest distance. determining, based on the request, a route for the trip between the starting location and the ending location having a predicted duration no greater than the target duration, the route including a waypoint between the starting location and the ending location determined based on the goal of the trip, and transmitting the route, via the communication device, to a source of the request for traveling the route.

An aspect of the disclosed implementations includes another apparatus for supporting travel through a transportation network. The apparatus includes a communication device and a processor. The processor is in connection with the communication device and may be configured to perform a method including transmitting, via the communication device, a request for a trip through the transportation network using a vehicle, wherein the request includes criteria for the trip and a goal for the trip, the criteria identifying a target duration of the trip, a starting location of the trip, and an ending location of the trip, and the goal is other than reaching the ending location from the starting location using a shortest time or a shortest distance, and receiving, via the communication device, a route for the trip between the starting location and the ending location, the route determined based on the request having a predicted duration no greater than the target duration, and the route including a waypoint between the starting location and the ending location determined based on the goal of the trip.

An aspect of the disclosed implementations includes a method for supporting travel through a transportation network, including receiving, via a communication source, a request for a trip through the transportation network using a vehicle, wherein the request includes criteria for the trip and a goal for the trip, the criteria identifying a target duration of the trip, a starting location of the trip, and an ending location of the trip, and the goal is other than reaching the ending location from the starting location using a shortest time or a shortest distance, determining, based on the request, a route for the trip between the starting location and the ending location having a predicted duration no greater than the target duration, the route including a waypoint between the starting location and the ending location determined based on the goal of the trip, and transmitting the route, via the communication source, to a source of the request for traveling the route.

Configuration of a processor may be achieved by instructions stored in memory that is associated with the processor, or may be achieved using the processor hardware, alone or in combination with such instructions.

These and other aspects of the present disclosure are disclosed in the following detailed description of the embodiments, the appended claims and the accompanying figures.

### BRIEF DESCRIPTION OF THE DRAWINGS

The disclosed technology is best understood from the following detailed description when read in conjunction with the accompanying drawings. It is emphasized that, according to common practice, the various features of the drawings may not be to-scale. On the contrary, the dimensions of the various features may be arbitrarily expanded or reduced for clarity. Further, like reference numbers refer to like elements throughout the drawings unless otherwise noted.

FIG. 1 is a diagram of an example of a vehicle with which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a flow chart diagram of a method for remotely supporting on-demand travel to a vehicle passenger in accordance with the present disclosure.

FIG. 4 is a block diagram of an apparatus or system for remotely supporting on-demand travel to a vehicle passenger in accordance with the present disclosure.

FIG. 5 is a map display including a representation of a geographical area.

### DETAILED DESCRIPTION

A vehicle, whether or not the vehicle is an autonomous vehicle, may be performing a service for a passenger or operator that includes traveling through a transportation network. The service may be a taxiing operation or shuttle operation, such as the pick-up or drop-off of a passenger, or may be a delivery operation, such as the pick-up or drop-off of cargo, such as a package. Like other determinations of a route, normal constraints such as the shortest path or the shortest time between start and end points are used for these services.

Oftentimes, however, a passenger has an interest in other than traveling between points in a geographic area. A passenger may wish to take a drive for the drive itself, for example, having a goal such as touring a point of interest, exploring a particular scenery, etc. A (e.g., on-demand) service that allows a passenger to specify and achieve such a goal may increase the utility of remote operation and support systems for vehicles, especially for autonomous vehicles.

To describe some implementations of the teachings herein in greater detail, reference is first made to the environment in which this disclosure may be implemented.

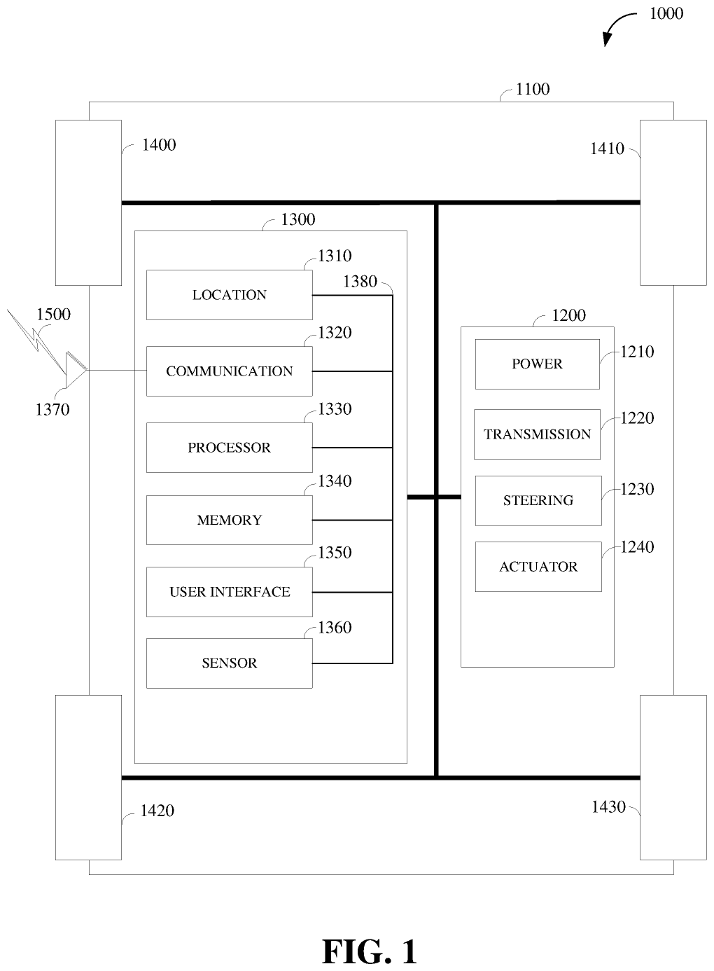

FIG. 1 is a diagram of an example of a vehicle 1000 with which the aspects, features, and elements disclosed herein may be implemented. The vehicle 1000 includes a chassis 1100, a powertrain 1200, a controller 1300, wheels 1400/1410/1420/1430, or any other element or combination of elements of a vehicle. Although the vehicle 1000 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1000, which can include accelerating, decelerating, steering, or otherwise controlling the vehicle 1000.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200.

The power source 1210 may be any device or combination of devices operative to provide energy, such as electrical energy, thermal energy, or kinetic energy. For example, the power source 1210 includes an engine, such as an internal combustion engine, an electric motor, or a combination of an internal combustion engine and an electric motor, and is operative to provide kinetic energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy, such as kinetic energy, from the power source 1210, and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1000.

In the illustrated embodiment, the controller 1300 includes a location unit 1310, an electronic communication unit 1320, a processor 1330, a memory 1340, a user interface (UI) 1350, a sensor 1360, and an electronic communication interface 1370. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now-existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an Application Specific Integrated Circuits, one or more Field Programmable Gate Array, one or more programmable logic arrays, one or more programmable logic controllers, one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

The processor 1330 may be configured to execute instructions including instructions for remote operation which may be used to operate the vehicle 1000 from a remote location including the operations center. The instructions for remote operation may be stored in the vehicle 1000 or received from an external source such as a traffic management center, or server computing devices, which may include cloud based server computing devices.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories (ROM), one or more random access memories (RAM), one or more random access memories (RAM), one or more registers, low power double data rate (LPDDR) memories, one or more cache memories, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultra violet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short range communications (DSRC) unit, a wireless safety unit (WSU), IEEE 802.11p (Wifi-P), or a combination thereof.

The location unit 1310 may determine geolocation information, including but not limited to longitude, latitude, elevation, direction of travel, or speed, of the vehicle 1000. For example, the location unit includes a global positioning system (GPS) unit, such as a Wide Area Augmentation System (WAAS) enabled National Marine-Electronics Association (NMEA) unit, a radio triangulation unit, or a combination thereof. The location unit 1310 can be used to obtain information that represents, for example, a current heading of the vehicle 1000, a current position of the vehicle 1000 in two or three dimensions, a current angular orientation of the vehicle 1000, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensor 1360 included, for example, a speed sensor, acceleration sensors, a steering angle sensor, traction-related sensors, braking-related sensors, or any sensor, or combination of sensors, that is operable to report information regarding some aspect of the current dynamic situation of the vehicle 1000.

In some embodiments, the sensor 1360 includes sensors that are operable to obtain information regarding the physical environment surrounding the vehicle 1000. For example, one or more sensors detect road geometry and obstacles, such as fixed obstacles, vehicles, cyclists, and pedestrians. The sensor 1360 can be or include one or more video cameras, laser-sensing systems, infrared-sensing systems, acoustic-sensing systems, or any other suitable type of on-vehicle environmental sensing device, or combination of devices, now known or later developed. The sensor 1360 and the location unit 1310 may be combined.

Although not shown separately, the vehicle 1000 may include a trajectory controller. For example, the controller 1300 may include a trajectory controller. The trajectory controller may be operable to obtain information describing a current state of the vehicle 1000 and a route planned for the vehicle 1000, and, based on this information, to determine and optimize a trajectory for the vehicle 1000. In some embodiments, the trajectory controller outputs signals operable to control the vehicle 1000 such that the vehicle 1000 follows the trajectory that is determined by the trajectory controller. For example, the output of the trajectory controller can be an optimized trajectory that may be supplied to the powertrain 1200, the wheels 1400/1410/1420/1430, or both. The optimized trajectory can be control inputs such as a set of steering angles, with each steering angle corresponding to a point in time or a position. The optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1000 under control of the transmission 1220, or a steered and propelled wheel that steers and propels the vehicle 1000.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

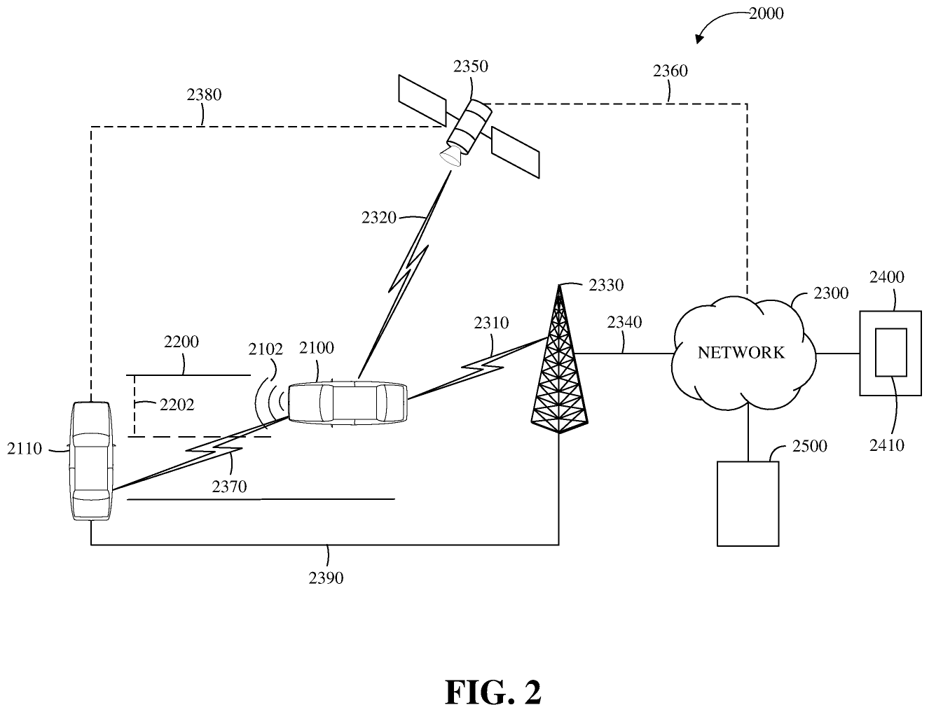

FIG. 2 is a diagram of an example of a portion of a vehicle transportation and communication system 2000 with which the aspects, features, and elements disclosed herein may be implemented. The vehicle transportation and communication system 2000 includes a vehicle 2100, such as the vehicle 1000 shown in FIG. 1, and one or more external objects, such as an external object 2110, which can include any form of transportation, such as the vehicle 1000 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network 2200, such as an off-road area. In some embodiments the transportation network 2200 may include one or more of a vehicle detection sensor 2202, such as an inductive loop sensor, which may be used to detect the movement of vehicles on the transportation network 2200.

Although only a single road in the transportation network 2200 is shown in FIG. 2 by example, the transportation network 2200 includes other components. For example, the transportation network 2200 may include unnavigable areas, partially navigable areas, such as parking areas, navigable areas, such as roads, or a combination thereof. An unnavigable area may be or encompass one or more static obstacles, such as buildings or points of interest.

The transportation network 2200 may include one or more interchanges between navigable areas, between navigable and partially navigable areas, and between partially navigable areas. The navigable areas, such as a road, may include one or more lanes, and may be associated with one or more directions of travel.

The transportation network 2200, or a portion thereof, may be represented as vehicle transportation network information. For example, vehicle transportation network information may be expressed as a hierarchy of elements, such as markup language elements, that may be stored in a database or file. For simplicity, the figures herein depict vehicle transportation network information representing portions of a vehicle transportation network as diagrams or maps; however, vehicle transportation network information may be expressed in any computer-usable form capable of representing a vehicle transportation network, or a portion thereof. The vehicle transportation network information may include vehicle transportation network control information, such as direction of travel information, speed limit information, toll information, grade information, such as inclination or angle information, surface material information, aesthetic information, or any combination thereof.

A portion, or a combination of portions, of the transportation network 2200 may be identified as a point of interest or a location. Locations may be identified by coordinates. Each of these locations may be a discrete uniquely identifiable geolocation. For example, the transportation network 2200 may include defined locations, each identified by a street address, a postal address, a vehicle transportation network address, a longitude and latitude, or a GPS address.

The electronic communication network 2300 may be a multiple access system that provides for communication, such as voice communication, data communication, video communication, messaging communication, or a combination thereof, between the vehicle 2100, the external object 2110, and an operations center 2400. For example, the vehicle 2100 or the external object 2110 may receive information, such as information representing the transportation network 2200, from the operations center 2400 via the electronic communication network 2300.

The operations center 2400 includes a controller apparatus 2410, which includes some or all of the features of the controller 1300 shown in FIG. 1. For example, the controller apparatus 2410 may include a processor such as described with regards to the processor 1330, a memory such as described with regards to the memory 1340, a communication device such as described with regards to the electronic communication unit 1320 and its related components, etc. The controller apparatus 2410 can monitor and coordinate the movement of vehicles, including autonomous vehicles. The controller apparatus 2410 may monitor the state or condition of vehicles, such as the vehicle 2100, and external objects, such as the external object 2110. The controller apparatus 2410 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 2410 can establish remote control over or remote support of one or more vehicles, such as the vehicle 2100, or external objects, such as the external object 2110. In this way, the controller apparatus 2410 may tele-operate or tele-assist the vehicles or external objects from a remote location. The controller apparatus 2410 may exchange (send or receive) state data with vehicles, external objects, or computing devices such as the vehicle 2100, the external object 2110, or a server computing device 2500, via a wireless communication link such as the wireless communication link 2380 or a wired communication link such as the wired communication link 2390.

The server computing device 2500 may include one or more server computing devices that exchange (send or receive) state signal data with one or more vehicles or computing devices including the vehicle 2100, the external object 2110, or the operations center 2400, via the electronic communication network 2300.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of electronic communication.

A vehicle, such as the vehicle 2100, or an external object, such as the external object 2110 may communicate with another vehicle, external object, or the operations center 2400. For example, a host, or subject, vehicle 2100 may receive one or more automated inter-vehicle messages, such as a basic safety message (BSM), from the operations center 2400, via a direct communication link 2370, or via an electronic communication network 2300. For example, operations center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

The vehicle 2100 may communicate with the electronic communication network 2300 via an access point 2330. The access point 2330, which may include a computing device, is configured to communicate with the vehicle 2100, with the electronic communication network 2300, with the operations center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the operations center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the operations center 2400 via the electronic communication network 2300, access point 2330, or satellite 2350. The operations center 2400 may include one or more computing devices, which are able to exchange (send or receive) data from vehicles such as the vehicle 2100, external objects including the external object 2110, or computing devices such as the server computing device 2500.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the operations center 2400. However, any number of vehicles, networks, or computing devices may be used. In some embodiments, the vehicle transportation and communication system 2000 includes devices, units, or elements not shown in FIG. 2.

Although the vehicle 2100 is shown communicating with the operations center 2400 via the electronic communication network 2300, the vehicle 2100 (and external object 2110) may communicate with the operations center 2400 via any number of direct or indirect communication links. For example, the vehicle 2100 or external object 2110 may communicate with the operations center 2400 via a direct communication link, such as a Bluetooth communication link. Although, for simplicity, FIG. 2 shows one of the transportation network 2200, and one of the electronic communication network 2300, any number of networks or communication devices may be used.

The external object 2110 is illustrated as a second, remote vehicle in FIG. 2. An external object is not limited to another vehicle. An external object may be any infrastructure element, e.g., a fence, a sign, a building, etc., that has the ability transmit data to the operations center 2400. The data may be, for example, sensor data from the infrastructure element.

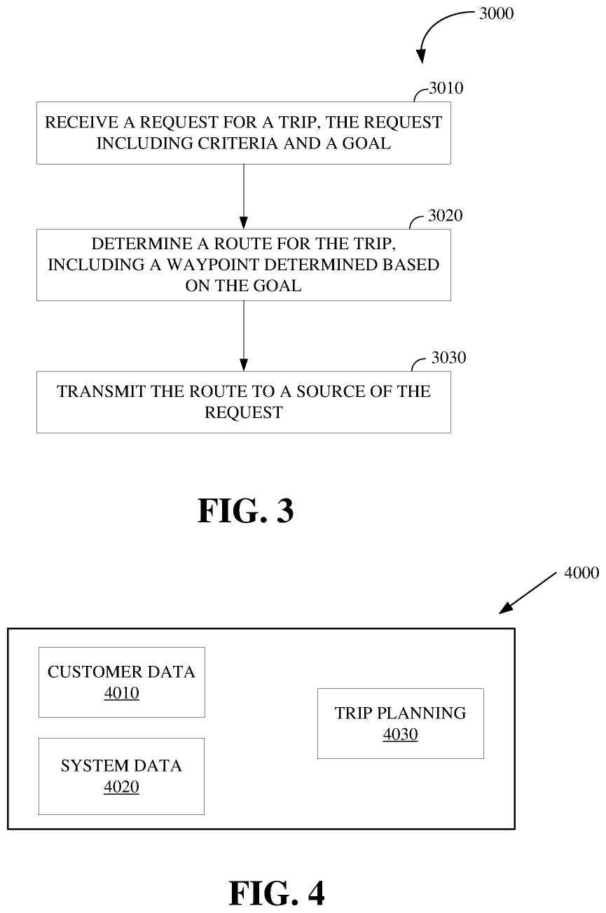

FIG. 3 is a flow chart diagram of a method 3000 for or remotely supporting on-demand travel to a vehicle passenger in accordance with the present disclosure. The method 3000 may be utilized by a remote support system, such as a fleet manager or a vehicle manager implemented at the operations center 2400, or another remote system providing support to a vehicle for traveling through a transportation network.

At operation 3010, a request for a trip through the transportation network using a vehicle, such as the vehicle 1000 or the vehicle 2100, is received. The vehicle can include a device or apparatus (e.g., a conveyance) that is used to transport a payload including any of one or more passengers and cargo. The vehicle can include any of an autonomous vehicle or a vehicle that is driven by a human driver or a semi-autonomous vehicle. The request may be generated by a passenger currently within a vehicle by a user interface, such as the user interface 1350. The request may be generated by a passenger, whether or not they are within a vehicle, by an application that permits communication of the passenger with the remote support, such as the operations center 2400. The request may be generated by a passenger for travel at a future point in time.

The request includes criteria for the trip and a goal for the trip. The criteria includes (e.g., determines or identifies) a target duration of the trip, a starting location of the trip, and an ending location of the trip. Each of the starting location and the ending location may be a street address, a building name, or some other identifier of a location within a geographical area, such as described with regard to the transportation network 2200 in FIG. 2. A location may be identified by, for example, GPS coordinates or map coordinates. In some implementations, the starting location and the ending location may be the same location. The starting location may be identified as a current location of the requestor.

The target duration of the trip may be specified in minutes, hours, or any other measure of time. The target duration may be included in the request. Alternatively, the target duration may be identified from the current time or a designated starting time at the starting location, along with an ending time at the ending location. The ending time and optionally the starting time may be included in the request.

The goal for the trip is other than reaching the ending location from the starting location using the shortest amount of time or the shortest distance for trip. In this way, for example, the final duration of the trip from the starting location to the ending location may exceed the shortest travel time from the starting location to the ending location, the total distance traveled between the starting location and the ending location may exceed the shortest travel distance between the starting location and the ending location, or both.

The goal for the trip may be one of a plurality of predetermined goals. In an example, each of the plurality of predetermined goals is associated with at least one respective tagged location within a geographical area such as shown by FIG. 2 that includes the transportation network. A tagged location may be a location corresponding to a point of interest, an iconic building in a city, a tourist destination, a university campus, a defined scenery, etc. Alternatively, or additionally, the goal may comprises traveling under specified weather conditions. In this latter example, the operations center 2400 may receive, using its communication device, weather forecast information. The goal may not be associated with a tagged location. For example, the goal may be to travel to any nearby lake to spend an hour there before a meeting at a specified time at the ending location, where the specified time may be included as part of the criteria. The goal may be to tour a portion of a geographical area for two hours, with the starting location and the ending location being the same location within a geographical area traversed by the transportation network.

Other examples of criteria and goals are described below in regards to FIG. 4.

At 3020, a route is determined for the trip based on the request. The trip is between the starting location and the ending location identified from the request. The route includes a waypoint between the starting locations and the ending location that is determined based on the goal of the trip.

The waypoint may be a tagged location associated with the goal. For example, the goal may be related to a defined scenery. A goal of riding quickly through a winding mountain road with a friend has a defined scenery of a winding mountain road. The tagged location may be a location corresponding to the defined scenery, such as a particular winding mountain road. A goal of inspecting construction sites in a city (alone or with others such as municipal government officials) has a defined scenery of construction sites. The tagged location may be a location corresponding to the defined scenery, such as a particular construction site. In another example, the goal may be related to a point of interest. A goal of touring a university campus and optionally on- or off-campus housing (e.g., for a prospective student) has a point of interest of the university campus. The tagged location may be a location corresponding to the point of interest, such an engineering building, a computer lab, etc. A goal of sightseeing iconic architecture has as a point of interest any building identified as having iconic architecture. The tagged location may be a location corresponding to such a building. In another example, the goal may be related to a tourist destination. A goal of seeing the Statute of Liberty from all angles has a tourist destination of the Statute of Liberty. The tagged location may be a location corresponding to the tourist destination, such as a vantage point for viewing the Statute.

While the above examples describe that the waypoint may be a location such as a tagged location that falls into one of a number of different categories, the categories listed above are not limiting. Any number of categories for locations are available. Further, locations can be included in more than one category. For example, the Statute of Liberty may be tagged as both a location corresponding to a point of interest and a location corresponding to a tourist destination.

The route may have more than one waypoint. The waypoint may be a first waypoint of a plurality of waypoints within a geographic area. Waypoints are points through which the route passes when traveling from the starting location to the ending location. The plurality of waypoints may share a common characteristic. The common characteristic may be included in the goal or the criteria. For example, the common characteristic may be a tagged location. In this example, the waypoints may be various locations surrounding the tagged location, such as described with respect to the Statute of Liberty example above. In another example, the common criteria may be a particular type of road on which to travel, such as a mountainous road, a shore drive, etc. In this example, the waypoints may identify the locations of roads and intersections between adjacent roads on the route that so that the route comprises a majority of roads having the common criteria as measured by distance or travel time.

The plurality of waypoints may include at least some stop locations. That is, one or more of the waypoints may represent a stop location along the route for egress and subsequent ingress of the passenger of a vehicle. For example, the passenger may wish to spend a period of time at the stop location to take photographs, read a book, obtain a closer view of a building, etc. Each stop location along the route can have a respective defined stop duration. A stop duration may be established by the passenger when making the request, or may be established when the stop is made.

The route has a predicted duration that is no greater than the target duration. The predicted duration is the sum of the amount of time to travel from the starting location, through each waypoint in sequence, and to the ending location. Where the route includes waypoints that represent stop locations, for example, each stop location may have a respective defined stop duration included in the predicted duration. It is worth noting that, while the route is determined at operation 3020 to have the predicted duration based on the target duration, the actual duration of the trip along the route may differ due to unexpected travel conditions. Further, the predicted duration may change if the passenger requests a change while traveling the route. For example, the passenger may request an earlier arrival time or a later arrival time at the ending location while traveling the route. This may modify the target duration so that a new predicted duration does not exceed the new target duration.

Further details of how to determine the route at operation 3020 are discussed below with regard to FIG. 4.

After the route is determined at operation 3020, the route is transmitted to a source of the request at operation 3030. The route may be transmitted via the communication device of the operations center 2400. When the source is a mobile device of the passenger (e.g., through an application or a website), the passenger may receive the route on the device. When the source is an interface of the vehicle, such as the UI 1350, the passenger may receive the route on the interface. When the vehicle is a service vehicle that is to travel the route, whether or not it is an autonomous vehicle, the vehicle can receive (e.g., wirelessly) and use the route. For example, the vehicle 1000 may receive the route via the electronic communication interface 1370 for use by the controller 1300. The controller 1300 may use the route in a navigation system for the passenger to follow, or may use the route to control the vehicle 1000 when the vehicle is an autonomous vehicle 1000.

FIG. 4 is a block diagram of an apparatus or system 4000 for remotely supporting on-demand travel to a vehicle passenger in accordance with the present disclosure. The system 4000 may be included in the operations center 2400 and perform methods according to implementations of this disclosure. The system 4000 may be implemented by the controller apparatus 2410, such as by the processor, the memory, and the communication device described previously.

The system 4000 includes customer data 4010 and system data 4020 that are provided to trip planning 4030. The customer data 4010 may be data provided as part of the request as described above, or may be data separately provided from a client. The customer data 4010 may also be stored in memory of the operations center 2400 from previous requests. The customer data 4010 may provide the criteria for determining the route, such as an amount of time available to the passenger, the starting location, and the ending location. The customer data 4010 may include other data that can be received with the request, such as the passenger's location when the request is made.

The customer data 4010 may include other data for use in the determination of the route. For example, the customer data 4010 may include customer preferences. The customer preferences may include a type of vehicle preferred by the passenger. The customer preferences may include interests of the passenger, such as whether the passenger prefers cultural tours, nature tours, or otherwise. The customer preferences may include hobbies of the passenger, such as how long the passenger prefers to linger at a particular category of locations. The customer preferences may include a driving style such as speed preferences of the customer (e.g., whether the customer prefers to travel as close to the speed limit as possible, or prefers to travel below the speed limit by a defined margin). The customer preferences may include media preferences, such as music preferences, of the passenger. The customer preferences may be used as criteria for the trip, as additional context for the goal of the trip, or as both.

The system data 4020 includes system information, such as the information of the transportation network 2200 described above with regard to FIG. 2. The system data 4020 may include any geographical information, topological information, meteorological information, or any combination of this information. The system data 4020 may include known information from the transportation network information of the transportation network 2200 described previously, may include information identified or tagged by the passenger or other customers using the system 4000, or may include some combination of this information.

The system data 4020 may include identifiers. For example, the system data 4020 may include street type identifiers, such as rural, scenic, city, country, public, private, etc. The system data 4020 may include identifiers for tagged locations, such as respective categories for the tagged locations. The system data 4020 may include identifiers of tourist spots, such as a name and a type of each tourist spot. The system data 4020 may include identifiers of subjective data, such as the ambience of neighborhoods, areas, or regions within the transportation network 2200. The system data 4020 may include weather information, road conditions, or both weather information and road conditions. The system data 4020 may include any other data useful to the determination of a route for a trip.

The trip planning 4030 uses the customer data 4010 and the system data 4020 as input to determine the route. The operations center 2400 may parse the request to define parameters for the criteria, goals, or both for determining the route. The parameters may be used as input for determining the route.

To determine the route, the trip planning 4030 at the operations center 2400 may include a cloud-based artificial intelligence (AI), such as one or more artificial neural networks. The networks can be trained to perform various tasks associated with determining the route. One neural network may parse the request. For example, touring a university campus can be parsed to identify buildings and other points of interest as possible waypoints for the route. The request may also be parsed to identify a starting time or an ending time, or other criteria, for the trip. For example, exploring one or more points of interest before attending a meeting a meeting at a defined time at the ending location may be parsed to identify the ending time, and points of interest in a region within a defined distance of the ending location. A goal of enjoying a particular piece of music (e.g., a song) with complementary scenery or watching an action movie with synchronized acceleration forces during the car-chase scenes may each be considered as a goal of determining the route to share at least one characteristic of the media item to be used during the trip, and may be parsed to define characteristics of the media item for comparison with possible waypoints between the starting and ending locations.

Another neural network may be used to determine a sequence and selection of the available waypoints based on inputs such as the historical traffic patterns along the possible routes formed by different arrangements of the possible waypoints, the target duration of the trip, the starting location, the ending location, stop locations and stop durations, or any combination thereof. For example, the criteria and goal may define the inputs, and the neural network model may solve to the target duration. That is, the output may comprise the route in the form of starting time and location, waypoints, any stop locations and durations, and ending time and location.

An operator interfacing with the operations center 2400 may be used to aid parsing of the request for input to the customer data 4010 and the system data 4020, and from there to the trip planning 4030.

To determine the route, the trip planning 4030 at the operations center 2400 may use, in addition to or alternatively to one or more AIs, deterministic techniques. In an example, once parameters are parsed from the request using AI or an operator, or a combination of each, different waypoint(s) and different sequence(s) using expected travel times between the starting location, at least one waypoint, and the ending location may be sequentially tested and modified until a route is determined that has an estimated duration that is no longer than the target duration.

In an example, determining the route for the trip includes determining a first sequential plurality of waypoints between the starting location and the ending location that corresponds to a first estimated duration for the trip. The first estimated duration includes an expected time to travel between the starting location and a first of the waypoints, between adjacent waypoints, and between a final waypoint and the ending location, and an expected stopping interval at respective ones of the waypoints. Then, upon a condition that the first estimated duration is greater than the target duration, a second sequential plurality of waypoints between the starting location and the ending location corresponding to a second estimated duration for the trip is determined. The second sequential plurality of waypoints includes fewer waypoints than the first sequential plurality of waypoints, the second sequential plurality of waypoints includes different waypoints than the first sequential plurality of waypoints, or both. Alternatively, upon a condition that the first estimated duration is less than the target duration by at least a defined amount, a second sequential plurality of waypoints between the starting location and the ending location corresponding to a second estimated duration for the trip is determined. The second sequential plurality of waypoints includes more waypoints than the first sequential plurality of waypoints, the second sequential plurality of waypoints includes different waypoints than the first sequential plurality of waypoints, or both. This process can continue until the estimated duration is below the target duration by less than the defined amount. The defined amount may be 5 or 10 minutes, for example. The defined amount can vary depending upon system conditions. For example, the defined amount can be a larger number when weather conditions are poor, than when weather conditions are clear. In another example, the defined amount can be a larger number when historical traffic patterns on portions of the route vary widely, than when traffic patterns are generally predictable.

As mentioned previously, a stop duration may be established while the passenger is traveling. For example, the stop duration for a waypoint may be set before or once the passenger reaches the waypoint, such that the waypoint becomes a stop location. In such an implementation, the passenger may communicate the desired stop duration to the operations center 2400 via a communication device. The operations center 2400 may recommend a shorter time for the stop location, or may generate a suggested revision to the remaining route to accommodate the desired stop duration.

In addition to the route, other recommendations for the trip may be determined and optionally transmitted to the source of the request. For example, the vehicle type for the trip may be determined when a personal vehicle is not used. In another example, personalized tour guide services may be determined, e.g., based on the final route waypoint(s). Using personal preferences, or based on characteristics of the route, for example, background entertainment (music, scent, etc.) for the trip may be recommended.

In some implementations, more than one route satisfies the criteria and goal, and has a duration of less than or equal to the predicted duration. Each route may be transmitted to the source of the request. A selection between the route choices may be made, e.g., by the passenger through the source described previously.

While the route herein is described in regards to starting and ending locations, and at least one waypoint, it should be recognized that connections between locations may be sent to recognize desired changes in direction through the transportation network in order to reach the next location. Further, where the vehicle is an autonomous vehicle, periodic target locations along a calculated trajectory based on the route may be transmitted as part of the route between starting, waypoint, and ending locations, for control of the autonomous vehicle.

While the goal of the trip is described as other than reaching the ending location from the starting location using a shortest time or a shortest distance, the shortest time and the shortest distance are not necessarily ignored. While at least one waypoint is decided based on the goal of the trip, once a waypoint is selected, reaching that waypoint from the starting location or a previous waypoint may consider the shortest time or distance. Similarly, route from the final waypoint to the ending location way consider the shortest time or the shortest distance.

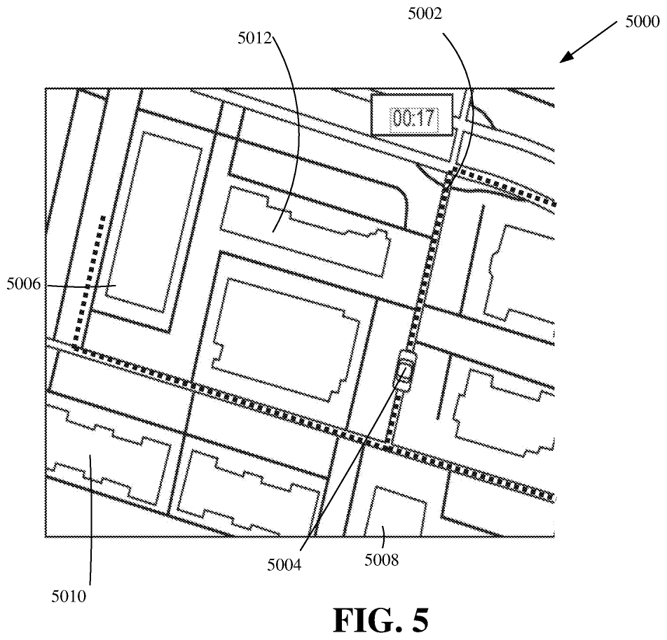

FIG. 5 is a map display 5000 including a representation of a geographical area. A transportation network is shown that may be used in the determination of a route 5002 of a vehicle 5004. In this example, only a portion of the route 5002 is shown, where the starting location and the ending location are the same location 5006. The goal includes performing a drive to familiarize the passenger with the area, and to stop of lunch at a park 5008. The park 5008 is a waypoint based on the goal. Other waypoints may correspond to features like a convenience store 5010, a church 5012, etc.

The disclosed technology provides for personalized, on-demand support for travel in a vehicle on public or private roads. The combination of criteria and a goal of a passenger, driver, or both, to generate a route for a trip provides the opportunity to engage in unique on-demand ride services. Further, the service provides new business opportunities for service vehicles, including fleet vehicles.

As used herein, the terminology “driver” or “operator” or “passenger” may be used interchangeably. As used herein, the terminology “computer” or “processor” or “controller” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise, or clear from context, “X includes A or B” is intended to indicate any of the natural inclusive permutations. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus for supporting travel through a transportation network, comprising:
a communication device; and
a processor in connection with the communication device and configured to perform a method comprising:
receiving, via the communication device, a request for a trip through the transportation network using a vehicle, wherein the request includes criteria for the trip and a goal for the trip, the criteria identifying a target duration of the trip, a starting location of the trip, and an ending location of the trip, and the goal is other than reaching the ending location from the starting location using a shortest time or a shortest distance;
determining, based on the request, a route for the trip between the starting location and the ending location having a predicted duration no greater than the target duration, the route including a waypoint between the starting location and the ending location determined based on the goal of the trip; and
transmitting the route, via the communication device, to a source of the request for traveling the route.

2. The apparatus of claim 1, wherein:
the goal for the trip is one of a plurality of predetermined goals, each of the plurality of predetermined goals associated with at least one respective tagged location within a geographical area including the transportation network; and
determining the route comprises selecting the waypoint based on the goal, the waypoint being a tagged location associated with the goal.

3. The apparatus of claim 2, wherein the tagged location is at least one of:
a location corresponding to a defined scenery;
a location corresponding to a point of interest; or
a location corresponding to a tourist destination.

4. The apparatus of claim 1, wherein the waypoint is a first waypoint of a plurality of waypoints within a geographical area that share a common characteristic, and the goal includes the common characteristic.

5. The apparatus of claim 4, wherein the common characteristic comprises a tagged location

6. The apparatus of claim 1, wherein the waypoint is a first waypoint of a plurality of waypoints within a geographic area, at least some of the plurality of waypoints representing a stop location along the route for egress and subsequent ingress of a passenger of the vehicle, each stop location having a respective defined stop duration included in the predicted duration.

7. The apparatus of claim 1, wherein the goal comprises traveling under specified weather conditions, and the method further comprises:
receiving, using the communication device, weather forecast information.

8. The apparatus of claim 1, wherein determining the route for the trip comprises:
determining a first sequential plurality of waypoints between the starting location and the ending location corresponding to a first estimated duration for the trip, the first estimated duration comprising an expected time to travel between the starting location and a first of the waypoints, between adjacent waypoints, and between a final waypoint and the ending location, and an expected stopping interval at respective ones of the waypoints.

9. The apparatus of claim 8, wherein determining the route for the trip comprises:
upon a condition that the first estimated duration is greater than the target duration, determining a second sequential plurality of waypoints between the starting location and the ending location corresponding to a second estimated duration for the trip, wherein at least one of:
the second sequential plurality of waypoints includes fewer waypoints than the first sequential plurality of waypoints, or
the second sequential plurality of waypoints includes different waypoints than the first sequential plurality of waypoints.

10. The apparatus of claim 8, wherein determining the route for the trip comprises:
upon a condition that the first estimated duration is less than the target duration by at least a defined amount, determining a second sequential plurality of waypoints between the starting location and the ending location corresponding to a second estimated duration for the trip, wherein at least one of:
the second sequential plurality of waypoints includes more waypoints than the first sequential plurality of waypoints, or
the second sequential plurality of waypoints includes different waypoints than the first sequential plurality of waypoints.

11. The apparatus of claim 1, wherein the communication device comprises a wireless transceiver receiving the request from a passenger for the trip, wherein the criteria for the trip comprises stored preferences associated with the passenger.

12. The apparatus of claim 11, wherein the stored preferences comprise at least one of a type of vehicle preferred by the passenger, interests of the passenger, hobbies of the passenger, or a driving style of the passenger.

13. An apparatus for supporting travel through a transportation network, comprising:
a communication device; and
a processor in connection with the communication device and configured to perform a method comprising:
transmitting, via the communication device, a request for a trip through the transportation network using a vehicle, wherein the request includes criteria for the trip and a goal for the trip, the criteria identifying a target duration of the trip, a starting location of the trip, and an ending location of the trip, and the goal is other than reaching the ending location from the starting location using a shortest time or a shortest distance; and
receiving, via the communication device, a route for the trip between the starting location and the ending location, the route determined based on the request having a predicted duration no greater than the target duration, and the route including a waypoint between the starting location and the ending location determined based on the goal of the trip.

14. A method for supporting travel through a transportation network, comprising:
receiving, via a communication device, a request for a trip through the transportation network using a vehicle, wherein the request includes criteria for the trip and a goal for the trip, the criteria identifying a target duration of the trip, a starting location of the trip, and an ending location of the trip, and the goal is other than reaching the ending location from the starting location using a shortest time or a shortest distance;
determining, based on the request, a route for the trip between the starting location and the ending location having a predicted duration no greater than the target duration, the route including a waypoint between the starting location and the ending location determined based on the goal of the trip; and
transmitting the route, via the communication device, to a source of the request for traveling the route.

15. The method of claim 14, wherein the starting location and the ending location are the same location within a geographical area traversed by the transportation network.

16. The method of claim 14, wherein the criteria includes at least one of a starting time for the trip or an ending time for the trip.

17. The method of claim 14, wherein the goal comprises a tour of a portion of a geographical area.

18. The method of claim 14, wherein the goal comprises determining the route to share at least one characteristic of a media item to be used during the trip.

19. The method of claim 18, wherein the media item comprises at least one of a song or a video.

20. The method of claim 14, wherein the goal is associated with at least one identifier, and the waypoint comprises a tagged location within the transportation network associated with the at least one identifier.
